(19) United States
(12) Patent Application Publication
(10) Pub. No.: US 2026/0243882 A1
(43) Pub. Date: Aug. 20, 2026

(54) A RADAR SENSOR, A LIGHTING DEVICE COMPRISING THE RADAR SENSOR, A METHOD FOR OPERATING THE RADAR SENSOR AND A LIGHTING SYSTEM COMPRISING THE RADAR SENSOR

(71) Applicant: SIGNIFY HOLDING B.V., EINDHOVEN (NL)

(72) Inventors: GANG WANG, SHANGHAI (CN); JIALONG QIU, SHANGHAI (CN); ZHIQUAN CHEN, SHANGHAI (CN); GONGMING WEI, SHANGHAI (CN); CHUN YANG, SHANGHAI (CN)

(21) Appl. No.: 19/161,788

(22) PCT Filed: Feb. 26, 2024
(86) PCT No.: PCT/EP2024/054803

§ 371 Date: Sep. 3, 2025

(30) Foreign Application Priority Data
Mar. 6, 2023 (WO) PCT/CN2023/079889
May 31, 2023 (EP) 23176309.5

(51) Int. Cl. G01S 13/56; H05B 47/115

(52) U.S. Cl. CPC G01S 13/56; H05B 47/115

(57) ABSTRACT

A radar sensor, comprising a radar frontend and a microcontroller unit, MCU, the radar frontend coupled to a processor of the MCU via an analogue to digital converter, ADC. The radar frontend is further arranged to be coupled to the processor of the MCU via a waveform converter and a pulse counter; the waveform converter is arranged to be coupled between the radar frontend and the pulse counter, for receiving the radar signals output by the radar frontend and converting the same to pulse signals to be input to the pulse counter; the pulse counter is arranged to be coupled between the waveform converter and the processor, for counting a number of the pulse signals from the waveform converter and for outputting triggering signals to the processor based on comparison results between a number of the pulse signals and a threshold value; the processor is configured to run an algorithm for processing radar signals from the radar frontend via the ADC when timing of the triggering signals from the pulse counter meets a particular condition.

### TECHNICAL FIELD

The present disclosure generally relates to the field of radar technologies, more particularly, to a radar sensor, a method of operating the same, a lighting device and a lighting system comprising the same.

### BACKGROUND

More and more lighting products are now equipped with motion sensors such that automatic light-on-demand function may be supported. Comparing with passive infrared, PIR, sensors, radar sensors, such as a 5.8 GHz doppler radar, have better performance in terms of motion/presence detection. As a result, radar sensors are becoming a dominating choice as sensor to be provided with lighting devices.

Power consumption of a radar sensor is higher than a PIR sensor as the radar sensor uses radio waves to detection motion and reflected signals have to be processed by a higher power processing unit.

Specifically, a radar sensor is an active radio frequency, RF, device which consumes power to radiate radar signals. On the other hand, a complicated signal processing algorithm has to run on a microcontroller unit, MCU, of the radar sensor such that satisfactory sensing performance is guaranteed. Such algorithm also consumes power.

When a smart light device with integrated radar sensor is at the standby mode, the radar sensor still needs to work so that light can be turned on timely when any valid motion is detected. This makes it more difficult for the lighting devices to meet the requirement of regulations on standby power consumption for lighting products, which are nowadays becoming stricter. Moreover some applications such as battery powered devices requires lower power radar sensors.

There are already solutions to reduce the power consumption of the radar sensor. For example, some radar sensors can work in duty/pulsed operation mode. That is, instead of continuously emitting radar signals, the radar sensor emits signal in high frequency pulses and emits no signal in between two pulses.

While this method may work with radar sensors for some applications, for lighting technologies, it is often needed that the power consumption for the radar sensor integrated with the lighting device may be further reduced. In this sense, existing solutions do not reduce the power consumption of radar sensors to a satisfactory extent. For example, only applying pulsed operation is just not enough, not to mention that some (low-cost) radar sensors do not support pulsed operation. This is especially true for power sensors integrated into lighting devices.

CN114415124B provides a method and device for automatic gain control of intermediate frequency signal based on upper and lower threshold value applied to a Doppler radar system. Doppler radar sensor chip uses a pulse counting method with fixed time period to measure the output pulse width of the comparator, and automatically adjusts the gain according to whether the upper and lower threshold is reached.

In consideration of the above, it is desirable that a radar sensor with further reduced power consumption and a method of operating such radar sensor are available.

### SUMMARY

In a first aspect of the present disclosure, there is presented a radar sensor, comprising a radar frontend and a microcontroller unit, MCU, the radar frontend coupled to a processor of the MCU via an analogue to digital converter, ADC,, wherein:
the radar frontend is further arranged to be coupled to the processor of the MCU via a waveform converter and a pulse counter;
the waveform converter is arranged to be coupled between the radar frontend and the pulse counter, for receiving the radar signals output by the radar frontend and converting the same to pulse signals to be input to the pulse counter;
the pulse counter is arranged to be coupled between the waveform converter and the processor, for counting a number of the pulse signals from the waveform converter and for outputting triggering signals to the processor based on comparison results between a number of the pulse signals and a threshold value (or called a number threshold value); and
the processor is configured to run an algorithm for processing radar signals from the radar frontend via the ACD when timing of the triggering signals from the pulse counter meets a particular condition.

The present disclosure is based on the insight that the power consumption of a radar sensor can be reduced by reducing or minimizing the working time of the ADC and the time that the processor runs an algorithm for detecting motions or presence of an object.

For the purpose of reducing the time that the processor spends on running the algorithm for detecting motions as well as the working time of the ADC, it is designed that the ADC only works thus the processor gets the digital signals and runs the algorithm when it is determined there is a high probability that a motion is present.

This is realized by introducing a low-power waveform converter between the radar frontend and the MCU of the radar sensor. Radar signals from the radar frontend are fed to the waveform converter and converted to pulse signals. The waveform converter operates together with a pulse counter, which is coupled between the waveform converter and the processor and arranged to count a number of pulse signals output by the waveform converter.

The number of pulse signals can be used as an indicator of the presence of a motion, when specific conditions are met. For this purpose, the number of pulse signals is designed to be associated with a triggering signal to the processor. When the processor is triggered for multiple times and timing of the trigger signals meet a particular condition, it can be determined that the probability that a motion is present is high enough. The processor accordingly starts the ADC and runs the algorithm for processing the digital radar signals so as to detect a possible motion.

Without using the radar sensor and the associated operating method of the present disclosure, the processor of the radar sensor runs the algorithm continuously, no matter the radar signal contains a possible motion or not. The radar sensor of the present disclosure only runs the algorithm for detecting motions when it is determined that the probability that a valid motion is present is high enough. This allows the processor and an associated ADC, independent of or integrated into the MCU of the radar sensor to remain in a low power mode for a much longer period of time, thereby reducing the overall power consumption of the radar sensor.

It will be understood by those skilled in the art that, in the present disclosure, the processor running the algorithm for detecting motions comprises also turning on the ADC such that the radar signals are converted to digital signals before being processed by the processor.

In an example of the present disclosure, for the radar sensor,
the pulse counter is arranged to output a triggering signal at a first time moment when a number of pulse signals reaches a first threshold value, and to output a triggering signal at a second time moment when a number of pulse signals reaches a second threshold value, and
the processor is configured to run the algorithm for processing radar signals from the radar frontend via the ADC when a time difference between the second time moment and the first time moment is smaller than a third threshold value.

As indicated above, radar signals from the radar frontend are converted to pulse signals by the waveform converter, and the number of pulse signals is used as an indicator of the presence of a motion, when specific conditions are met.

In the present disclosure, when the number of pulse signals reaches a threshold value, a triggering signal is output from the pulse counter to the processor of the MCU of the radar sensor.

It can be contemplated by those skilled in the art that when the number of pulse signals reaches or exceeds a threshold value only once, for example in a relatively long period of time like several minutes or even several hours, it is most likely that no actual motion is present.

In contrast, when the number of pulse signals reaches or exceeds a threshold value multiple times, especially when a time difference between a first time moment when a number of pulse signals reaches a first threshold value and a second time moment when a number of pulse signals reaches a second threshold value is quite short, say below a third threshold value, it is a strong indication that this is a motion detection.

Only when a time difference between the second time moment and the first time moment is small enough, such as being smaller than a third threshold value, will the processor turn on the ADC, allowing the processor to get digital radar signals to run the algorithm. This helps to allow the MCU to stay in a low power mode for a longer time, thereby saving the overall power consumption of the radar sensor.

In an example of the present disclosure, the ADC is integrated in the MCU.

It can be contemplated by those skilled in the art that most currently available MCUs have one or more ADC integrated therein. Such MCUs including integrated ADCs may be conveniently used in the radar sensor of the present disclosure.

In an example of the present disclosure, the waveform converter comprises a comparator arranged to compare an amplitude of the radar signal with a threshold value (or called an amplitude threshold value) and to output a pulse when the amplitude of the radar signal is higher than the threshold value.

It can be contemplated by those skilled in the art the waveform convertor may be implemented as an ultra-low power circuit such as comprising a comparator, which can be conveniently used to convert radar signals into a square wave.

This is a readily available design which is accessible to a skilled person and sufficient to perform the function of converting the analogue radar signals to a square wave pulse signal.

A second aspect of the present disclosure provides a lighting device comprising the radar sensor according to the first aspect of the present disclosure.

Such a lighting device will have reduced power consumption comparing with a lighting device integrating a conventional radar sensor, which allows the lighting device conform to power consumption regulations.

A third aspect of the present disclosure presents a method for operating the radar sensor according to the first aspect of the present disclosure, the method performed by the processor of the radar sensor and comprising the step of:
determining that timing of the triggering signals from the pulse counter meets a particular condition; and
running the algorithm for processing radar signals from the radar frontend, the radar signals output to the processor via the ADC.

The method of operating the radar sensor makes it possible to allow the MCU of the radar sensor to operate in a low power mode as long as possible when there is no motion. In other words, the processor of the MCU is asked to run the algorithm only when there is a high probability that a motion is coming. The method thereby helps to reduce the overall power consumption of the radar sensor.

In an example of the present disclosure, the determining step comprises:
setting the first threshold value for the pulse counter for counting a number of pulse signals output by the waveform converter in response to receiving radar signals;
starting the pulse counter followed by entering a power saving mode;
being waked up from the power saving mode by the triggering signal and recording a first time moment when the first threshold value of the pulse counter is reached;
setting the second threshold value for the pulse counter, the second threshold value being smaller than the first threshold value;
restarting the pulse counter followed by entering the power saving mode;
being waked up from the power saving mode by the triggering signal and recording a second time moment when the second threshold value of the pulse counter is reached;
calculating a time difference between the first time moment and the second time moment, and
determining that timing of the triggering signals from the pulse counter meets a particular condition by deciding that the time difference is smaller than the third threshold value.

The above is an exemplary example of using triggering signals output by the pulse counter to wake up the processor when the number of pulse signals reaches a defined threshold value and making the processor to run the algorithm when the time difference between two occurrences when the number of pulse signals reaches the defined threshold value(s) is small enough, that is, below the third threshold value.

When the time difference between two occurrences when the number of pulse signals reaches the defined threshold value(s) is smaller than the third threshold value, it is decided or confirmed that the particular condition for asking the processor to run the algorithm for processing the radar signals from the radar frontend via the ADC is met. On other occasion, though the processor can get woke up by the triggering signals, it only records a time moment, set a further threshold value and goes back to the power saving mode again. This helps to keep the power consumption of the radar sensor low.

In an example of the present disclosure, the first threshold value is set based on a number of interferences to be accommodated by the radar sensor.

An interference is a non-valid motion such as electromagnetic interference from a lighting device comprising the radar sensor or a fluttering curtain due to wind. The first threshold value can be adjusted based on the desired interference that is tolerated by the radar sensor.

In an example of the present disclosure, the second threshold value is set based on an expected sensitivity of the radar sensor.

Similarly, in a further example of the present disclosure, the third threshold value is set based on an expected sensitivity of the radar sensor.

The second threshold value, which determines when the processor will be woke up again after being woke up once, and the third threshold value, which determines the time difference between the first and second time that the processor is woke up, can be set based on the expected sensitivity of the radar sensor. This allows flexibility with the operation of the radar sensor.

In an example of the present disclosure, the triggering signal comprises a counter overflow interrupt output by the pulse counter.

A counter overflow interrupt which is used in a known MCU may be conveniently used as the triggering signal.

In an example of the present disclosure, the method further comprising the following step after the determining step:
stopping the pulse counter.

As the processor now has to processor the radar signals from the radar frontend via the ADC, it is not necessary to count the pulse signals from the waveform converter anymore, the pulse counter can therefore be stopped.

In an example of the present disclosure, further comprising the following step after the determining step:
waking up the ADC such that radar signals from the radar frontend are converted to digital signals before being processed by the algorithm.

The ADC may also be set to a low power mode when the processor is not processing the radar signals and only starts to convert the received analogue radar signals to digital signals for the processor to process when the processor starts to run the algorithm. This helps to further save the power consumption of the radar sensor.

A fourth aspect of the present disclosure provides a lighting system comprising a lighting device and the radar sensor according to the first aspect of the present disclosure, wherein the radar sensor is operated according to the method of the third aspect of the present disclosure when the lighting device enters a standby mode.

A fifth aspect of the present disclosure provides a computer program product, comprising a computer readable storage medium storing instructions which, when executed on at least one processor, cause said at least one processor to carry out the method according to the third aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 schematically illustrates a conventional radar sensor.

FIG. 2 schematically illustrates, in a block diagram, a radar sensor according to an embodiment of the present disclosure.

FIG. 3(a) and 3(b) schematically illustrate output of the waveform converter for different radar signals.

FIG. 4 schematically illustrates an exemplary diagram of such a waveform converter circuit.

FIG. 5 schematically illustrates using a timer of a Microcontroller unit to count pulses.

FIG. 6 schematically illustrates an example of using a timer of a MCU to count the number of pulses from the waveform converter and to generate an counter overflow interrupt event when the threshold is reached.

FIG. 7 schematically illustrates, in a flow chart type diagram, an embodiment of a method of operating the radar sensor of FIG. 2 in accordance with the present disclosure.

FIG. 8 schematically illustrates an IF signal from the radar sensor and counter values over a time period of one hour, during which there is no valid motion.

FIG. 9 is a zoom-in view of FIG. 8, showing the counter value over a period of about 35 seconds around the 39th minute.

FIG. 10 shows the IF signal and counter value over about 30 seconds which contains motions of a walking person approaching the radar sensor.

FIG. 11 is a zoom-in view of FIG. 10, it shows that the counter value from the 9^{th} second to the 13^{th} second.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

Throughout this description, the phrase “a/the number of” is used to refer to a/the quantity or count of occurrence of signals. In other words, the phrase is used to refer to a total number obtained or recorded by noting each thing (in the present disclosure a pulse or a pulse signal) as it is being added.

Throughout this description, the terms “power saving mode” and “low power mode” are used interchangeably to refer to a mode of a radar sensor where most or all of operations of a Microcontroller unit, MCU, of the radar sensor are suspended to reduce energy consumption. The low power mode may comprise for example an idle, sleep, stop or standby mode of the radar sensor.

In the present disclosure, in the power saving mode or low power mode of the radar sensor, a processor of the MCU does not run an algorithm for processing radar signals from a frontend module of the radar sensor and an analogue to digital converter, ADC, of the radar sensor does not convert the radar signals from the radar frontend to digital signals.

Moreover, a standby mode of a lighting device used in the description refers to a state when the lighting device is switched off.

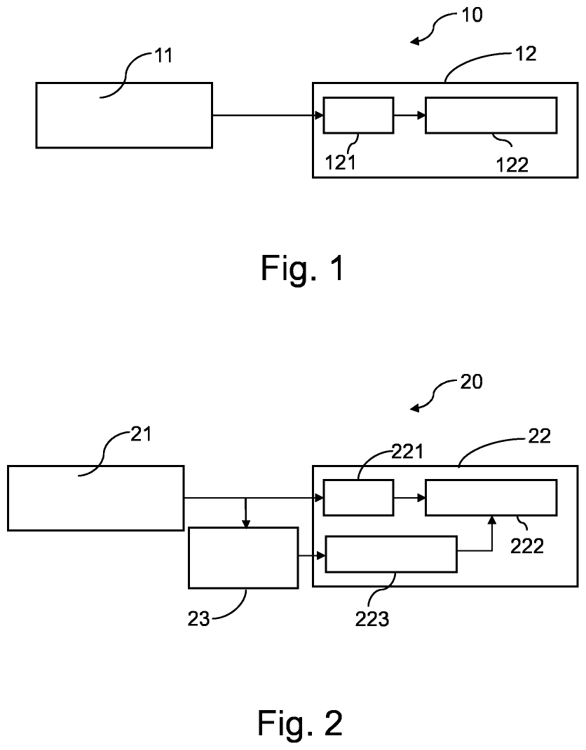

FIG. 1 schematically illustrates a conventional radar sensor 10 comprising two parts: a radar frontend 11 and a MCU 12. The radar frontend 11 is configured for radiating radar signal and receiving reflected signals to generate intermediate frequency, IF, signal as output. The MCU comprises an ADC 121 and a processor 122. The ADC 121 is configured to take the analogue IF signal from the radar frontend 11 as input, to convert it to digital signals and output the digital signals to the processor 122 for further processing by an algorithm which runs on the processor 122. The algorithm may be for example a digital signal processing algorithm, or a motion or presence detection algorithm for detecting the presence or motion of an object or subject within a sensing range of the radar sensor 10.

For a low-cost 5.8 GHz radar sensor which does not support duty operation, the power consumption of the radar frontend is in a range of from dozens of milliwatt to a few hundred milliwatt (e.g., 80-300 mW), depending on its radiation power. The MCU, when running the digital signal processing algorithm, can consume 100-150 mW.

As discussed in the background part, it is desirable that the power consumption of conventional radar sensors as the one illustrated in FIG. 1 be further reduced.

For this purpose, this present disclosure proposes to further reduce the power consumption of a radar sensor by introducing a lower power path from the frontend module to the processor of the MCU of the radar sensor.

Specifically, the MCU, or the processor thereof, of the radar sensor consumes much more power when running the signal processing algorithm than when it is in a low power mode not running the algorithm. Keeping the MCU in low power mode as much as possible when there is no motion, or in other words, asking the MCU to run the algorithm only when there is a high probability that a motion is coming, can reduce the power consumption of the radar sensor.

Based on the above insight, an ultra-low power analogue circuit, in combination with a timer of the MCU working as a pulse counter, processes the IF signal from the radar frontend to determine a probability of a valid motion. The MCU stays at low power mode for most of the time, while only runs the algorithm when the determined probability of a valid motion is high enough.

When the radar sensor is integrated or connected to a lighting device requiring low power consumption, it allows the power consumption of the lighting system comprising the lighting device and the radar sensor to be reduced further, when the lighting device is at a standby mode.

FIG. 2 schematically illustrates, in a block diagram, a radar sensor 20 according to an embodiment of the present disclosure. The radar sensor 20 comprises a radar frontend 21, a MCU 22, and a waveform converter 23. The MCU 22 comprises an ADC 221 and a processor 222 as well as a pulse counter 223.

Although the ADC 221 is illustrated in FIG. 2 as being a part of the MCU 22, in practice it may also be a component independent of the MCU 22.

The waveform converter 23 is configured to be coupled between the radar frontend 21 and the pulse counter 223 of the MCU 22, for receiving the IF radar signals output by the radar frontend 21 and converting the same to pulse signals to be input to the pulse counter 223.

The pulse counter 223 is coupled between the waveform converter 23 and the processor 222. It will be described in the following that the pulse counter 223 is configured for counting a number of the pulse signals from the waveform converter 23 and for outputting triggering signals to the processor 222 based on comparison results between a number of the pulse signals and a threshold value.

In practice, a waveform of the IF signal output by the radar frontend 21 can be seen as an irregular sine wave with a varying amplitude and frequency. Simply put, the amplitude of the IF signal is determined by a radar cross section, RCS, of an object in motion, while the frequency of the IF signal is determined by a velocity of the object in motion.

In addition to being input to the ADC 221 of the MCU 22, the IF signal is further provided to the waveform converter 23 which converts the IF signal into a square wave with a fixed amplitude and a varying frequency.

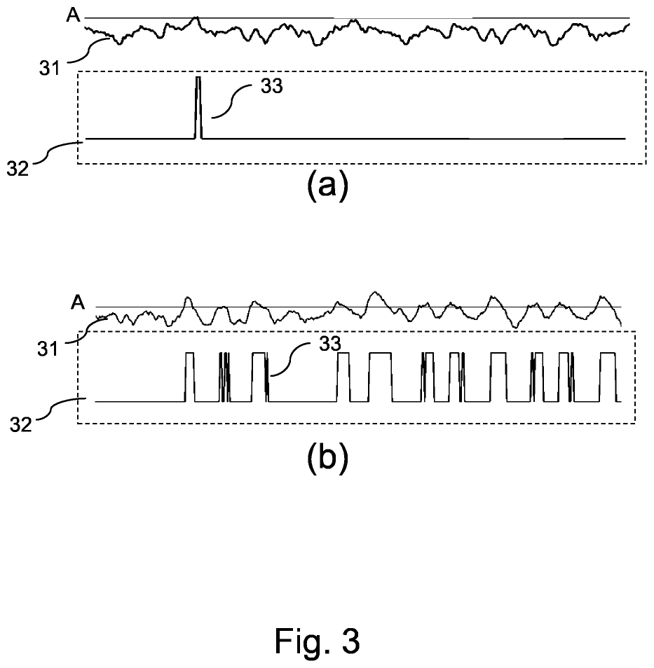

Referring to FIG. 3(a), for each irregular period, if the amplitude of the IF signal 31 goes higher than a pre-defined threshold A, the waveform converter 23 will generate a pulse 33 in its output signal indicated in a dashed box 32. When there is no motion in the detection area of the radar sensor, the amplitude of the IF signal keeps at a rather low level for most of the time. Then the output 32 of the waveform converter 23 is almost a straight line without or with just few pulses, as shown in FIG. 3(a) where only one period exceeds the threshold A.

When there is a valid motion such as a person walks into the detection area of the radar sensor, both the amplitude and the frequency of the IF signal varies in a rather large range. Then the output 32 of the waveform converter 23 contains much more pulses 33, as shown in FIG. 3(b).

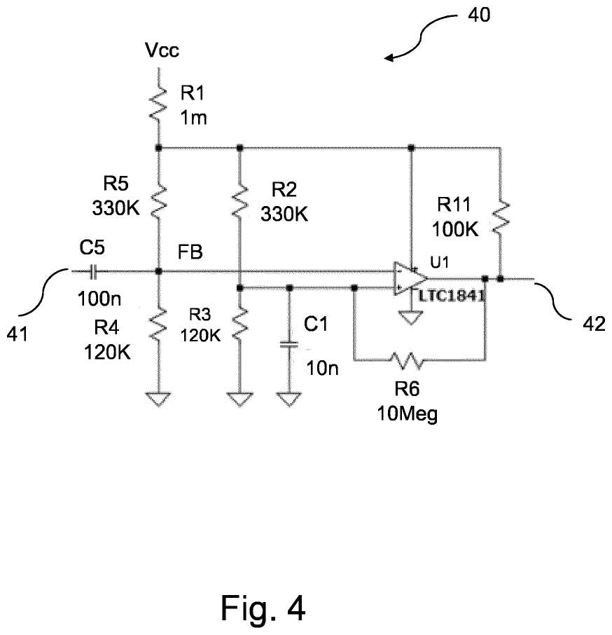

The waveform converter 23 is implemented as an analog circuit. FIG. 4 schematically illustrates an exemplary diagram of such a circuit 40. The circuit 40 comprises a comparator Ul and several resistors and capacitors. The waveform converter 23 is an ultra-low power circuit. Just for illustration, to convert a 300 Hz regular sine wave signal into a 300 Hz square wave signal, the power consumption of the circuit 40 in FIG. 4 is just 0.2 mW.

The radar signals from the radar frontend are input via an input terminal 41 of the circuit 40, and output signals from terminal 42 of the waveform converter is connected to the pulse counter.

The pulse counter 223 can be a timer of the MCU 22. Many modern MCUs contain timers which can count pulses in a square wave signal. When the counted pulses reach a pre-defined value, the timer outputs an interrupt to e.g., wake up the MCU 22 from a low power mode, such as an idle/sleep/stop/standby mode, to a normal working mode.

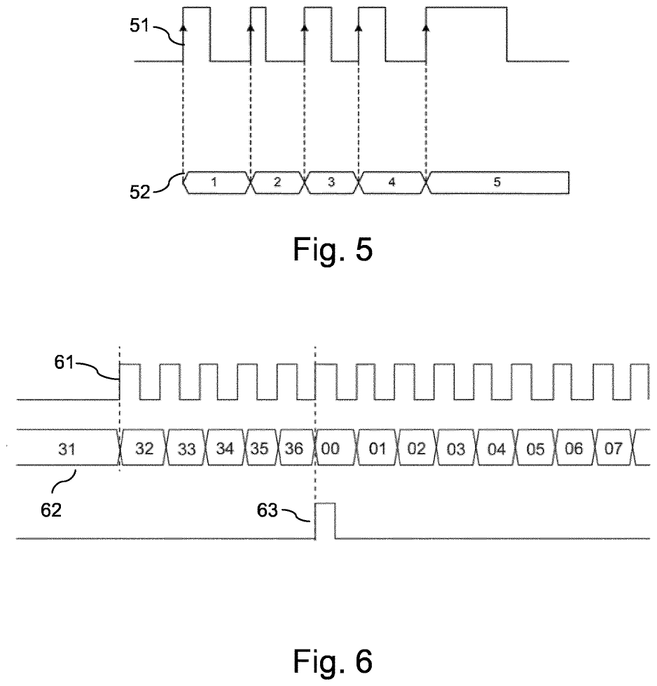

For example, the advanced control timer and low power timer of many STM32 MCUs can all realize such pulse counter function as illustrated in FIG. 5. In FIG. 5, the timer detects a rising edge 51 of a pulse and increases the counter 52 by 1.

A scenario of the radar sensor of the present disclosure being integrated or connected to a lighting device will be discussed in the following. When the lighting device is at a standby mode, for the purpose of reducing the power consumption of the MCU of the radar sensor as illustrated in FIG. 2, the radar sensor enters a low power mode. The radar sensor being in a low power mode means that both the ADC for converting the radar signals to digital signals and the processor for running the signal processing algorithm stop working while the timer of the MCU keeps working as a pulse counter.

According to measurements, this can save about 100-150 mW of power consumed by the radar sensor. The timer works in an up-counting mode, counting from 0 to a threshold N which is a pre-set value in a corresponding register. When the threshold value N is reached, a counter overflow event is generated as an interrupt to wake up the MCU. Then the counter restarts from 0.

FIG. 6 schematically illustrates an example of using a timer of a MCU to count the number of pulses from the waveform converter and to generate an counter overflow interrupt event when the threshold is reached.

In FIG. 6, the number 62 of pulses 61 output from the waveform converter are counted by the timer working as the pulse counter. The threshold value N is set to 36.

Therefore, when the counter reaches 36, an counter overflow interrupt or event 63 is generated by the timer.

The counter overflow interrupt wakes up the processor. When the lighting device is at standby mode, to realize lower power operation of the radar sensor while still ensuring its sensing performance, the working procedure of the MCU is specifically designed based on the characteristics of the IF signal induced by motions.

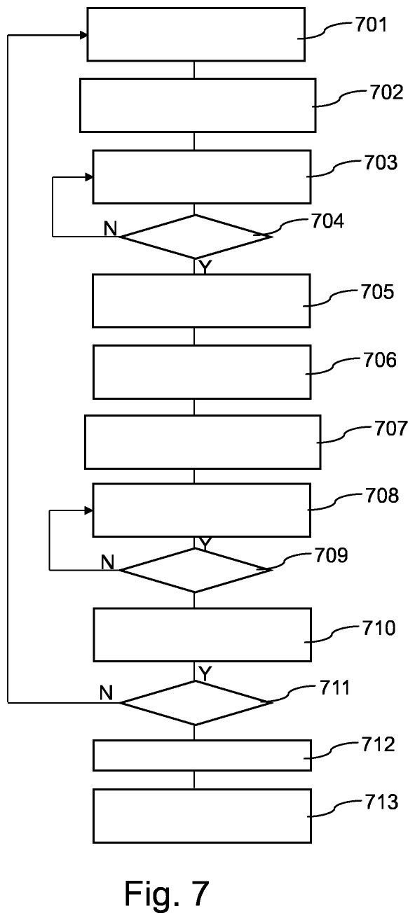

FIG. 7 schematically illustrates, in a flow chart type diagram, an embodiment of a method of operating the radar sensor of FIG. 2 in accordance with the present disclosure.

The procedure starts when the radar sensor is about to enter a low power mode. This can be the result of for example a lighting device comprising the radar sensor enters a standby mode, meaning that light is turned off after the radar sensor detects no motion for the pre-defined hold-on time, such as for example 5 min.

At step 701, the MCU sets a first threshold value N1 for the pulse counter or the timer.

Following that, at step 702, the timer is started and the MCU enters the low power mode, i.e., the ADC and the processor of the MCU stops working to save power.

At step 703, the timer of the MUC counts pulses from the waveform converter, the counting starts from 0. Step 704 checks whether the number of pulses has reached the first threshold value N1 of the counter or not.

Once the counted pulses reach N1, that is, when step 704 has a positive decision result, the timer generates a counter overflow interrupt, which wakes up the MCU, specifically, the processor of the MCU, at step 705. After waking up, the ADC still keeps stopped and the processor does not run signal processing algorithm. The processor checks and records the current time T1, which is a first time moment when the pulse counter reaches the first threshold value.

Following that, at step 706, the processor of the MCU sets a second threshold value N2 for the timer. The timer then starts and the MCU enters the low power mode again at step 707.

At step 708, the timer counts the pulses again from 0 and once the counted pulses reach N2 (step 709 has a positive decision Y), it generates a counter overflow interrupt to wake up the MCU again.

At step 710, the processor is woke up and checks and records the current time as T2, which is a second time moment when the pulse counter reaches the second threshold value.

At step 711, the processor calculates a difference between of the second time moment T2 and the first time moment T1. If the difference is smaller than the pre-defined threshold T3, it indicates the probability of a motion is high enough. Therefore the timer stops working at step 712 and the ADC and processor start working at step 713 to execute an algorithm for detecting motion or presence of an object.

It is noted that at this moment the ADC is also woke up, such that radar signals input to the ADC are converted to digital signals which are then processed by the processor using the sensing or motion/presence detection algorithm.

It can be understood by those skilled in the art that after the sensing algorithm detects no motion for the pre-defined hold-on time, the lighting device enters standby mode then the procedure starts over from step 701.

If the difference of T2 and T1 is equal or bigger than the threshold T3, that is, when the decision at step 711 has a negative result, indicating that the probability of a motion is not high enough, the procedure goes back to step 701. That is, the MCU sets the threshold of the timer (back) to N1 and enters the low power mode just as it enters the low power mode the first time after the procedure starts, then the procedure continues.

The above method of operating the radar sensor of the present disclosure essentially comprises the steps of first determining that timing of the triggering signals from the pulse counter meets a particular condition and then running the algorithm for processing radar signals from the radar frontend via the ADC.

The radar sensor is normally used together with another electronic device, which generally requires that the radar sensor monitors and detects motion in a reliably way. It is therefore that the requirement of reducing the power consumption of the radar sensor is balance with providing satisfactory sensing performance.

For the purpose of reducing the power consumption of the radar sensor as much as possible while ensuring its sensing performance, that is, to minimize false positive and false negative, values of the first and second threshold values N1, N2 and the threshold value T3 for the time difference between the first time moment T1 when the first threshold value is reached and the second time moment T2 when the second threshold value is reached need to be selected appropriately.

Refer back to FIG. 3(a), when there is no motion, there is hardly a pulse in the output signal of the waveform converter. Therefore, the counter of the timer increases very slow over time. When there is an interference, i.e., a non-valid motion such as electromagnetic interference from the lighting device or a fluttering curtain due to wind, the IF signal may fluctuate, thereby generating more pulses within a very short period in the output signal of the waveform converter.

Generally, the first threshold value N1 for the pulse counter is set to a value which allows a reasonable number of interferences to be accommodated before waking up the MCU.

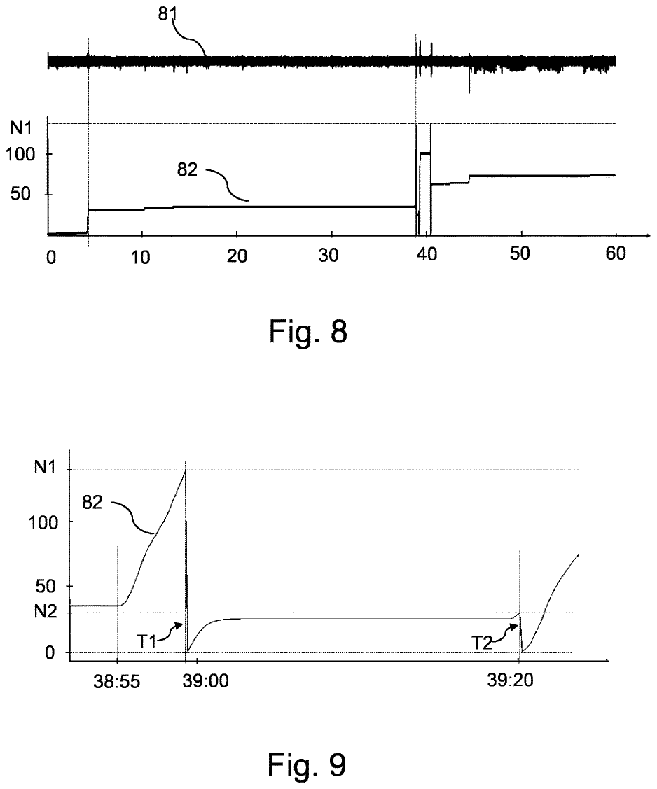

FIG. 8 schematically illustrates an IF signal 81 from the radar sensor and counter values 82 over a time period of one hour, during which there is no valid motion. As an example, the first threshold value N1 is set as 140 for illustrative purpose only. There are a few minor interferences in the IF signal 81 over the first few minutes therefore the counter value 82 increases very slowly. At around the 4^{th} minute, there is a moderate interference and the counter value 82 quickly increases to around 30. Afterwards the counter value 82 increases very slowly until around the 39^{th} minute, when the counter value 82 quickly increased to N1(140) due to a big interference.

FIG. 9 is a zoom-in view of FIG. 8, showing the counter value over a period of about 35 seconds around the 39th minute. The counter value increases from 35 to N1 (140) in around 4 seconds, that is from 38 minute 55 second to 38 minute 59 second. The MCU then wakes up for the first time at the time moment of 38 minute 59 seconds, which is recorded as T1. The second threshold of the timer is set to N2, then the MCU enters low power mode again.

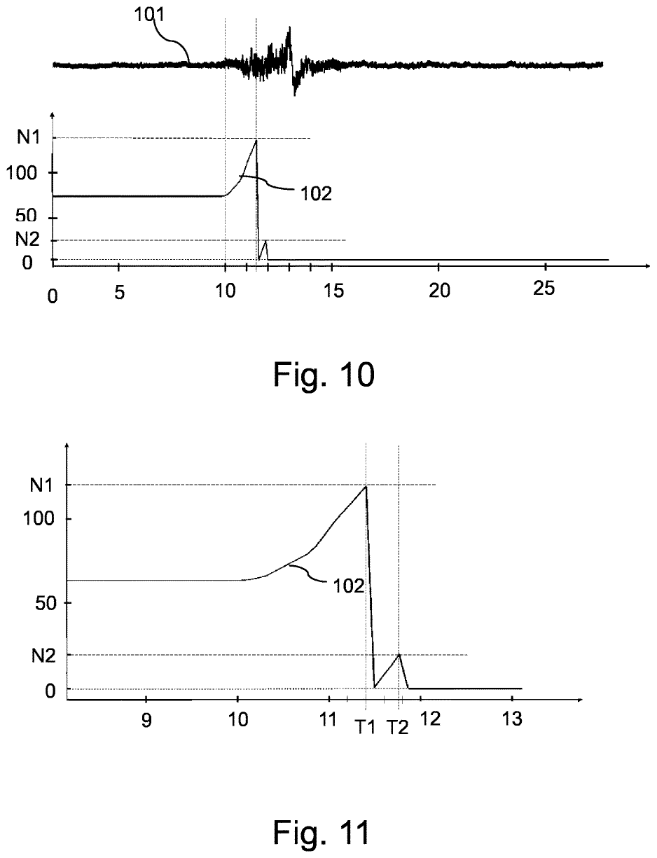

When there are valid motions, the counter value will also increase quickly to reach N1. FIG. 10 shows the IF signal 101 and counter value 102 over about 30 seconds which contains motions of a walking person approaching the radar sensor.

At around the 10th second, the person arrives at the edge of the detection area of the radar sensor. Within less than 2 seconds, the counter value 102 increased to N1 (140). In this case, i.e., the counter reaches N1 due to a valid motion, then the MCU must be woke up as soon as possible to run the algorithm to detect/confirm the motion. Therefore, N2 should be much smaller than N1 according to the working procedure of FIG. 7. However, on the other hand when the counter reaches N1 due to interferences as illustrated in FIG. 8, it is preferred not to wake up the MCU to run the algorithm. To realize this, T3 which is the duration between the counter reaches N1 (i.e., T1) and N2 (i.e., T2), plays a key role.

As an example, the second threshold value N2 is set as 30 and the threshold value T3 for the time difference between T2 and T1 is set as 0.4 second.

For the example of FIG. 9 where no valid motion is present, at (or right after) T1, the timer restarts counting from 0. In around 3 seconds, the counter value increases to 25 due to e.g., another moderate interference. The counter value stays at 25 for almost 20 seconds and increases to N2 (30) at 39:20. The MCU wakes up again, checks and records the current time as T2 (i.e., 39:20). Since the difference of T1 and T2 is more than 20 seconds, much larger than the threshold T (i.e., 0.4 second), which shows that the likelihood of a valid motion being present is rather low, the MCU just goes back to the low power mode.

Referring to FIG. 11 which is a zoom-in view of FIG. 10, it shows that the counter value 102 from the 9^{th} second to the 13^{th} second. At (or right after) T1, the timer restarts counting from 0. Within less than 0.4 second, the counter value 102 increased to N2 (30). Since the difference of T1 and T2 is less than T3 (0.4 s), the timer stops working and the ADC and processor starts working to execute the sensing algorithm. After T2, although there are big variations in the IF signal, the counter value keeps at 0 because the timer has stopped working.

It will be understood by those skilled in the art that the first threshold value N1 is selected based on a number of interferences to be accommodated by the radar sensor, while the second threshold value N2 and the third threshold value T3 is selected based on an expected sensitivity of the radar sensor.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1. A radar sensor, comprising a radar frontend and a microcontroller unit, MCU, the radar frontend coupled to a processor of the MCU via an analogue to digital converter, ADC, wherein:
the radar frontend is further arranged to be coupled to the processor of the MCU via a waveform converter and a pulse counter;
the waveform converter is arranged to be coupled between the radar frontend and the pulse counter, for receiving the radar signals output by the radar frontend and converting the same to pulse signals to be input to the pulse counter;
the pulse counter is arranged to be coupled between the waveform converter and the processor, for counting a number of the pulse signals from the waveform converter and for outputting triggering signals to the processor based on comparison results between a number of the pulse signals and a number threshold value; and
the processor is configured to run an algorithm for processing radar signals from the radar frontend via the ADC when timing of the triggering signals from the pulse counter meets a particular condition; wherein:
the pulse counter is arranged to output a triggering signal at a first time moment when a number of pulse signals reaches a first threshold value, and to output a triggering signal at a second time moment when a number of pulse signals reaches a second threshold value, and
the processor is configured to run the algorithm for processing radar signals from the radar frontend via the ADC when a time difference between the second time moment and the first time moment is smaller than a third threshold value.

2. The radar sensor according to claim 1, wherein the ADC is integrated in the MCU.

3. The radar sensor according to claim 1, wherein the waveform converter comprises a comparator arranged to compare an amplitude of the radar signal with an amplitude threshold value and to output a pulse when the amplitude of the radar signal is higher than the amplitude threshold value.

4. A lighting device comprising the radar sensor according to claim 1.

5. A method for operating the radar sensor according to claim 1, the method performed by the processor of the radar sensor and comprising the step of:
determining that timing of the triggering signals from the pulse counter meets a particular condition; and
running the algorithm for processing radar signals from the radar frontend, the radar signals output to the processor via the ADC; wherein the determining step comprises:
setting the first threshold value for the pulse counter for counting a number of pulse signals output by the waveform converter in response to receiving radar signals;
starting the pulse counter followed by entering a power saving mode;
being waked up from the power saving mode by the triggering signal and recording a first time moment when the first threshold value of the pulse counter is reached;
setting the second threshold value for the pulse counter, the second threshold value being smaller than the first threshold value;
restarting the pulse counter followed by entering the power saving mode;
being waked up from the power saving mode by the triggering signal and recording a second time moment when the second threshold value of the pulse counter is reached;
calculating a time difference between the first time moment and the second time moment, and
determining that timing of the triggering signals from the pulse counter meets a particular condition by deciding that the time difference is smaller than the third threshold value.

6. The method according to claim 5, wherein the first threshold value is set based on a number of interferences to be accommodated by the radar sensor.

7. The method according to claim 5, wherein the second threshold value is set based on an expected sensitivity of the radar sensor.

8. The method according to claim 5, wherein the third threshold value is set based on an expected sensitivity of the radar sensor.

9. The method according to claim 5, wherein the triggering signal comprises a counter overflow interrupt output by the pulse counter.

10. The method according to claim 5, further comprising the following step after the determining step:
stopping the pulse counter.

11. The method according to claim 5, further comprising the following step after the determining step:
waking up the ADC such that radar signals from the radar frontend are converted to digital signals before being processed by the algorithm.

12. A lighting system comprising a lighting device and the radar sensor according to claim 1 when the lighting device enters a standby mode.

13. A computer program product, comprising a computer readable storage medium storing instructions which, when executed on at least one processor, cause said at least one processor to carry out the method according to claim 5.
